(19) United States
(12) Patent Application Publication
(10) Pub. No.: US 2014/0051273 A1
(43) Pub. Date: Feb. 20, 2014

(54) POWER STRIP

(71) Applicants: HONG FU JIN PRECISION INDUSTRY (SHENZHEN) CO., L, Shenzhen (CN); HON HAI PRECISION INDUSTRY CO., LTD., New Taipei (TW)

(72) Inventors: YU HAN, Shenzhen (CN); HAN-BING ZHANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/689,772

(22) Filed: Nov. 30, 2012

(30) Foreign Application Priority Data
Aug. 15, 2012 (CN) 201210289707X

(51) Int. Cl. H01R 13/453

(52) U.S. Cl. CPC H01R 13/453
USPC 439/136

(57) ABSTRACT

A power strip includes a base, a cover, and a torsion spring. A socket is formed on a top of the base, for connecting a plug. The cover is pivotably connected to a rear end of the socket. A notch is defined in a front end of the cover. The torsion spring is connected between the cover and the socket, to bias the cover to cover the socket. When plugging the plug into the socket, the cover is rotated to expose the socket and the notch engages with and presses an extension portion on a top of the plug under an elastic force of the torsion spring, for preventing the plug from loosening.

### BACKGROUND

1. Technical Field

The present disclosure relates to a power strip.

2. Description of Related Art

On many power strips, a cover is pivotably mounted to a socket of the power strip, for protecting the socket from moisture and dust. When a plug is connected to the socket, the cover is pivoted open and rests against the plug, and has no other function. Many have experienced plugs disengaging from sockets accidentally, and the inconvenience of having to reinsert the plugs, which is troublesome.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a partial, exploded, isometric view of an exemplary embodiment of a power strip.

FIG. 2 is an enlarged, isometric view a circled portion II of FIG. 1.

FIGS. 3 and 4 are assembled, isometric views of FIG. 1 from different perspectives.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

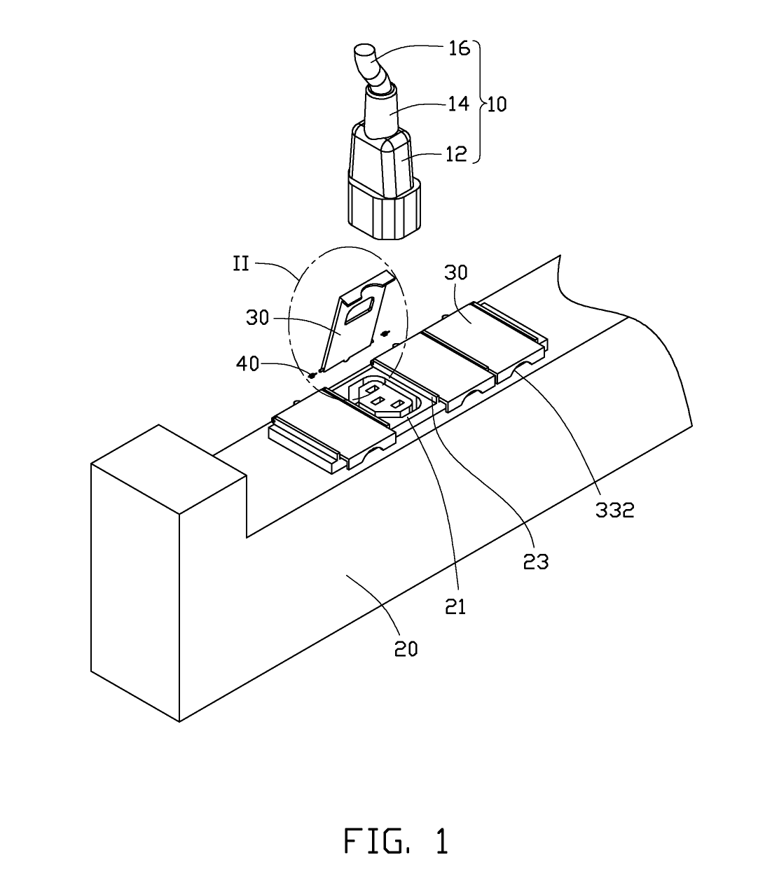

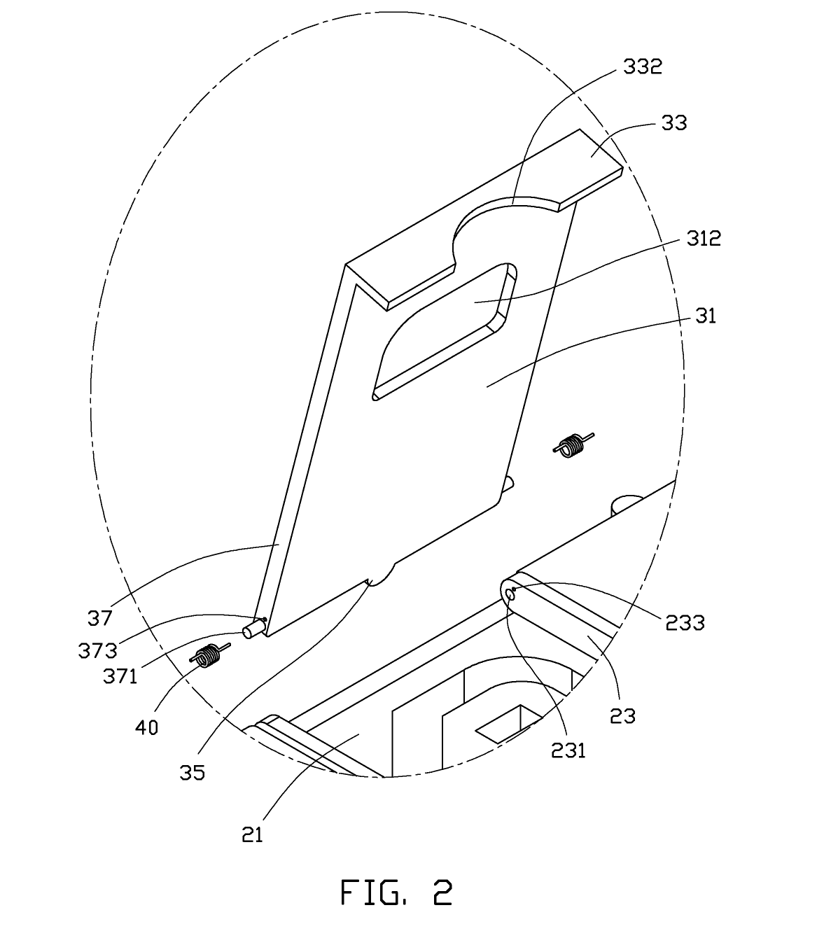

FIGS. 1 and 2 show an embodiment of a power strip for connecting a plurality of plugs 10. The power strip includes an elongated base 20, a plurality of covers 30, and a plurality of torsion springs 40.

Each plug 10 includes a main body 12, an extension portion 14 protruding from the top of the main body 12, and a cable 16 extending through the extension portion 14 and electrically connected to the main body 12.

A plurality of parallel stop plates 23 is formed on the top of the base 20. A socket 21 protrudes from the top of the base 20 between every two adjacent stop plates 23. A pivot hole 231 and a first fixing hole 233 are defined in the rear end of each stop plate 23.

Each cover 30 includes a shield plate 31. A flange 33 extends from the front end of the shield plate 31 in a perpendicular manner. An arc-shaped protrusion 35 extends rearward from the middle of the rear end of the shield plate 31. The shield plate 31 includes two opposite sides 37. A pivot 371 protrudes from the rear end of each side 37, and a second fixing hole 373 is defined in each side 37 adjacent to the corresponding pivot 371. A recess 312 is defined in an inner surface of the shield plate 31 facing the flange 33 and adjacent to the flange 33. A notch 332 is defined in the middle of a side of the flange 33 away from the shield plate 31.

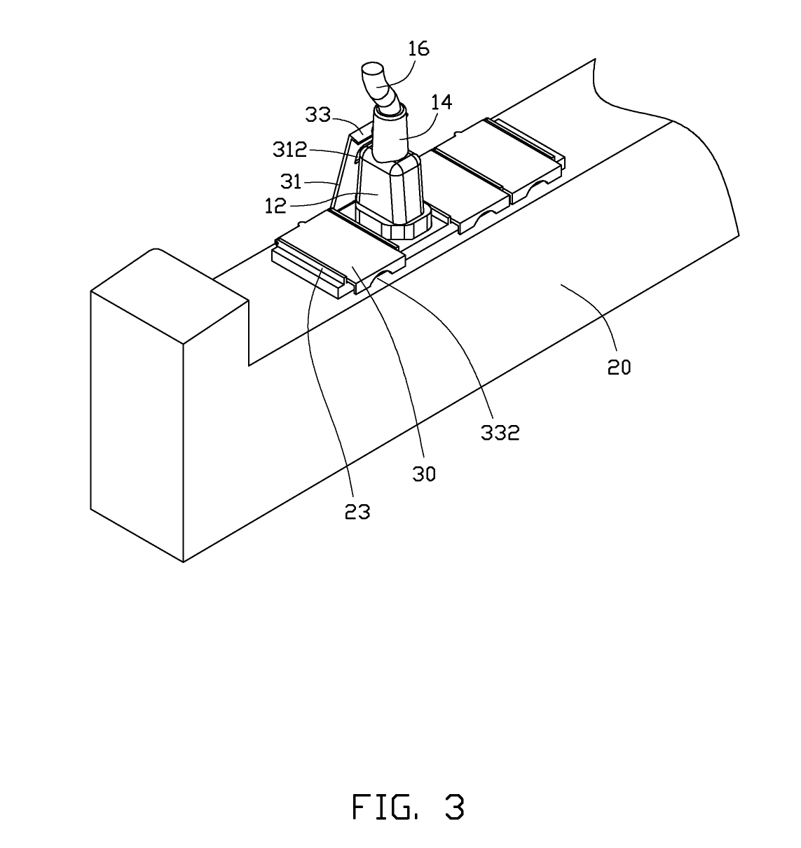

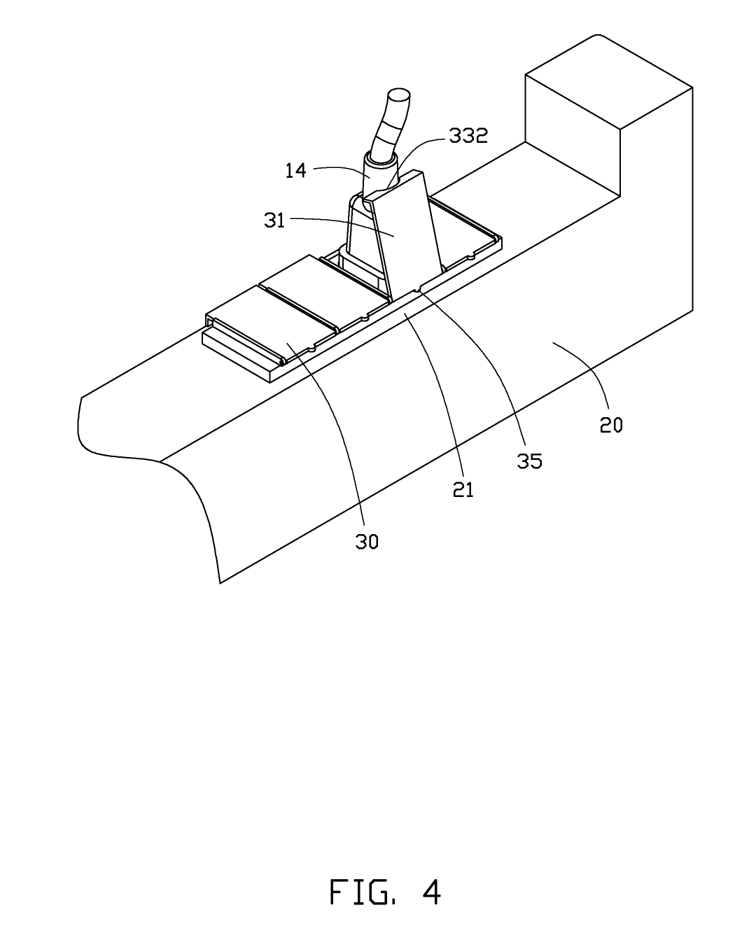

FIGS. 3 and 4 show that in assembly of a cover 30, two torsion springs 40 are respectively placed around the pivots 371, with first ends of the torsion springs 40 engaged in the corresponding second fixing holes 373. The pivots 371 are respectively engaged in two pivot holes 231 at opposite sides of a socket 21. Second ends of the torsion springs 40 are respectively engaged in the first fixing holes 233 at the opposite sides of the socket 21. Thereby, the cover 30 is pivotably connected to the rear end of the socket 21. Elastic forces of the torsion springs 40 bias the cover 30 to rotate to cover the socket 21. The shield plate 31 is arranged between the stop plates 23 at opposite sides of the socket 21, and the flange 33 abuts against the front end of the socket 21.

The other covers 30 are pivotably connected to the rear ends of the other sockets 21. When the sockets 21 are idle, the covers 30 cover the sockets 21 under the elastic forces of the torsion springs 40, to protect the sockets 21 from moisture and dust.

To connect a plug 10 to a socket 21, a finger of a user is inserted into the notch 332 of the cover 30 on the socket 21, to rotate the cover 30 open, until the shield plate 31 is perpendicular to the top of the socket 21, and the protrusion 35 abuts against the rear end of the socket 21. The torsion springs 40 connected to the cover 30 are deformed. The main body 12 is connected to the socket 21. The cover 30 is released. The torsion springs 40 are restored to bias the cover 30 to rotate closed, until a side of the main body 12 facing the cover 30 engages in the recess 312, and the extension portion 14 engages in the notch 332. The cable 16 and the top of the extension portion 14 are exposed out of the cover 30 from the notch 332. The elastic forces of the torsion springs 40 bias the cover 30 to press the main body 12 and the extension portion 14 down, to prevent the plug 10 from loosening.

Even though numerous characteristics and advantages of the embodiments have been set forth in the foregoing description, together with details of the structure and the functions of the embodiments, the disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A power strip, comprising:
a base forming a socket on a top of the base, for connecting a plug;
a cover pivotably connected to a rear end of the socket, wherein a notch is defined in a front end of the cover, away from the rear end of the socket; and
at least one torsion spring connected between the cover and the socket, to bias the cover to cover the socket;
wherein, when plugging the plug into the socket, the cover is rotated to expose the socket and the notch engages with and presses an extension portion on a top of the plug under an elastic force of the at least one torsion spring, for preventing the plug from loosening.

2. The power strip of claim 1, wherein the socket protrudes from the top of the base, the cover comprises a shield plate pivotably connected to the socket, and a flange extending from a front end of the shield plate, the notch is defined in a side of the flange away from the shield plate, when the cover covers the socket, the flange abuts against a front end of the socket.

3. The power strip of claim 2, wherein two stop plates are arranged at opposite sides of the socket, a pivot hole is defined in a rear end of each stop plate, the shield plate of the cover comprises two opposite sides, a pivot protrudes from a rear end of each side of the shield plate, to pivotably engage in the pivot hole of a corresponding one of the stop plates.

4. The power strip of claim 3, wherein a first fixing hole is defined in each stop plate adjacent to the corresponding pivot hole, a second fixing hole is defined in each side of the shield plate adjacent to the corresponding pivot, the number of the at least one torsion spring is two, the two torsion springs are respectively placed around the pivots of the cover, first ends of the two torsion springs are engaged in the second fixing holes of the sides of the cover, and second ends of the two torsion springs are engaged in the first fixing holes of the stop plates.

5. The power strip of claim 2, wherein a recess is defined in an inner surface of the shield plate adjacent to the flange, for engaging with and pressing down a side of a main body of the plug below the extension portion under the elastic force of the at least one torsion spring.

6. The power strip of claim 5, wherein a protrusion extends rearward from a rear end of the shield plate, when the cover is rotated to be perpendicular to the top of the socket, the protrusion abuts against the rear end of the socket.
